(19) United States
(12) Patent Application Publication
(10) Pub. No.: US 2012/0144339 A1
(43) Pub. Date: Jun. 7, 2012

(54) ELECTRONIC READER AND METHOD FOR PREVIEWING FILES IN ELECTRONIC READER

(75) Inventors: HUI-LING HUANG, Shenzhen City (CN); XIAO-GUANG LI, Shenzhen City (CN); QUAN-QUAN LIU, Shenzhen City (CN); HONG-YE LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/108,998

(22) Filed: May 17, 2011

(30) Foreign Application Priority Data
Dec. 4, 2010 (CN) 201010573635.2

(51) Int. Cl. G06F 3/048

(52) U.S. Cl. 715/776

(57) ABSTRACT

An electronic reader includes a storage unit, a display unit, and a processing unit. The processing unit displays a page of a file on the display unit, detects touch signals in response to a slide operation on an input unit; determines in real time a slide distance of a slide and a resizing proportion of the page corresponding to the slide distance to resize the page according to the real time resizing proportion; determines the number of the resized pages that can be displayed side by side in a document window of the display unit according to the last determined resizing proportion of the page; and displays the resized pages in the document window. A method for previewing files is also provided.

### BACKGROUND

1. Technical Field

The present disclosure relates to electronic readers and methods for previewing files and, particularly, to an electronic reader and a method for previewing files capable of selecting the number of preview pages on an interface of the electronic reader.

2. Description of the Related Art

Mechanical buttons are usually provided on an electronic reader for users to flip through an electronic file displayed on the electronic reader. However, repeated pressing of the buttons to go through pages may give rise to boredom.

### BRIEF DESCRIPTION OF THE DRAWINGS

The components of the drawings are not necessarily drawn to scale, the emphasis instead being placed upon clearly illustrating the principles of an electronic reader and a method for previewing files. Moreover, in the drawings, like reference numerals designate corresponding parts throughout multiple views.

FIG. 1 is a schematic view of a resized page of a file displayed on an electronic reader in accordance with an exemplary embodiment.

FIG. 2 is a block diagram of the electronic reader of FIG. 1.

FIG. 3 is a schematic view of a preview interface showing a plurality of pages with continuous page number, the pages include the resized page of FIG. 1.

FIG. 4 is a schematic view of a preview interface showing a plurality of pages with discontinuous page number, the pages include the resized page of FIG. 1.

FIG. 5 is a flowchart of a method for previewing files applied in the electronic reader of FIG. 1 in accordance with an exemplary embodiment.

### DETAILED DESCRIPTION

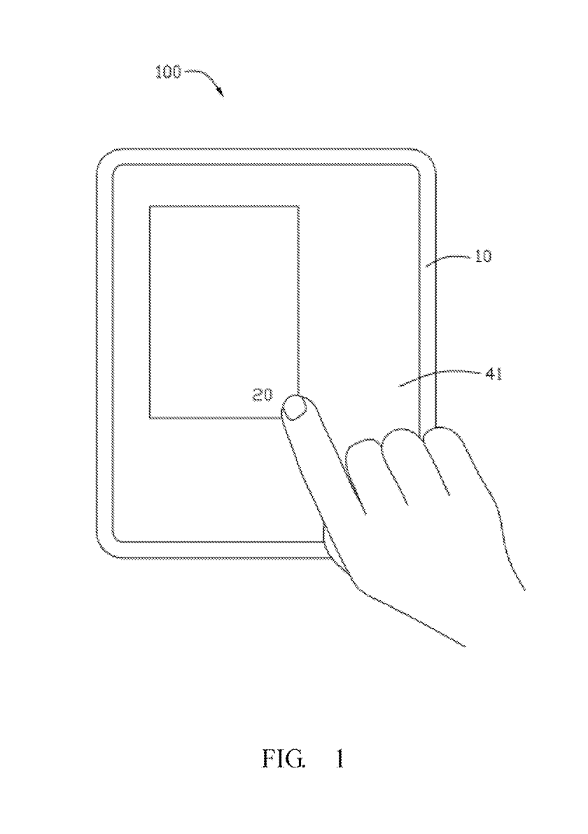

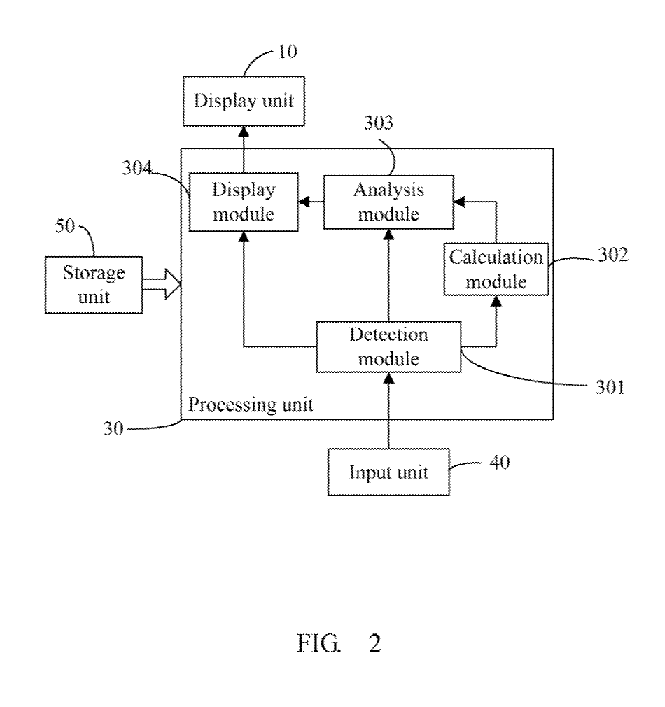

Referring to FIGS. 1 and 2, an electronic reader 100 includes a display unit 10, a storage unit 50, a processing unit 30, and an input unit 40. The storage unit 50 stores electronic files. The input unit 40 is a touch panel overlaying the display unit 10. The touch panel generates touch signals in response to touch operations. The processing unit 30 displays a page 20 of a selected file in a document window of the display unit 10 according to the touch signals generated in response to an open document operation. The processing unit 30 further determines a slide distance of a slide operation on the page 20 and a resizing proportion of the page 20 corresponding to the slide distance according to the touch signals generated in response to a slide operation on the page 20 and continuously change the size of the page 20 corresponding to the resizing proportion. The processing unit 30 further determines how many pages are to be capable of being displayed side by side in the document window, obtaining and displaying a suitable number of pages side by side in the document window for previewing. The displayed pages include the resized page 20 and pages following the resized page 20. The pages following the resized page 20 have a same size as the resized page 20 and hereinafter all are collectively referred to as “the resized pages”.

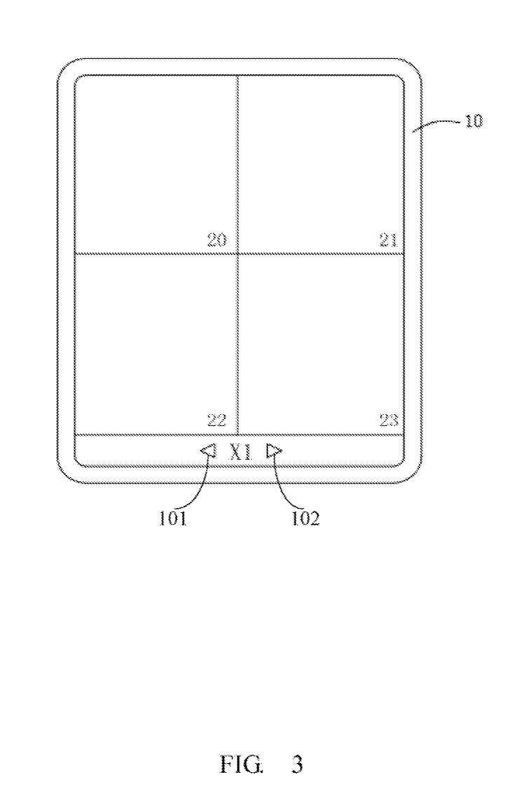

The display unit 10 is for displaying electronic files and the resized pages. The resized pages display in the document window side by side and may be continuous or discontinuous in page number. If the resized pages displayed in the document window side by side are discontinuous, a particular number of pages between every two adjacent resized pages displayed in the document window are concealed. Referring to FIG. 3, when the resized pages are displayed in the document window, a forward direction button 101 and a backward direction button 102 are also displayed below the resized pages, the buttons 101 and 102 are provided for the users to adjust the number of pages concealed in the document window. In this embodiment, the forward direction button 101 is provided for users to reduce the number of pages concealed. When the number of pages concealed is reduced to zero, the resized pages displayed in the document window side by side become continuous in page number. The backward direction button 102 is provided for the users to increase the number of pages concealed. When the number of pages concealed is increased from zero to a particular number, the resized pages displayed in the document window side by side become discontinuous in page number.

In the embodiment, the input unit 40 may include a mode button (not shown) and a preview button (not shown), the mode button and the preview button are configured for instructing the electronic reader 100 to enter a reading mode and a preview mode respectively. In other embodiments, the mode button and the preview button may be mechanical buttons fixed on the electronic reader 100. When the electronic reader 100 enters the reading mode, a home page of a selected file is displayed on the display unit 11. Users can drag a diagonal line of the home page to resize the page (see FIG. 1). Users can also drag a vertical edge of the home page along a horizontal direction to resize the page and/or drag a horizontal edge of the home page along a vertical direction to resize the page. In a word, users can resize the current page to a suitable size according to their preference.

The processing unit 30 includes a display module 304, a detection module 301, a calculation module 302, and an analysis module 303. The display module 304 displays a page 20 of a selected file on the display unit 10 in response to an open file operation. The detection module 301 detects sliding touch signals in response to a slide operation on the page and transmits the sliding touch signals to the calculation module 302. The calculation module 302 determines a slide distance and a resizing proportion of the page 20 corresponding to the slide distance according to a pre-stored table and continuously resizes the page according to the real time resizing proportion. The table records the relation between the slide distance and the resizing proportion of the page. Referring to Table 1, Table 1 is an example of the table and records a number of relations between a number of slide distances and a number of resizing proportions. In Table 1, 1 cm slide distance corresponds to a resizing proportion 90%; 3 cm slide distance corresponds to a resizing proportion 60%.

TABLE 1

| Sliding distance | Resizing proportion |
|---|---|
| 1 cm | 90% |
| 2 cm | 80% |
| 3 cm | 60% |
| 4 cm | 40% |
| 5 cm | 20% |
| 6 cm | 10% |
| 7 cm | 5% |

The calculation module 302 calculates the size of the page 20 according to a determined resizing proportion and resizes the page 20 in real time. The display module 304 on the display unit 10 dynamically displays the real time resized process.

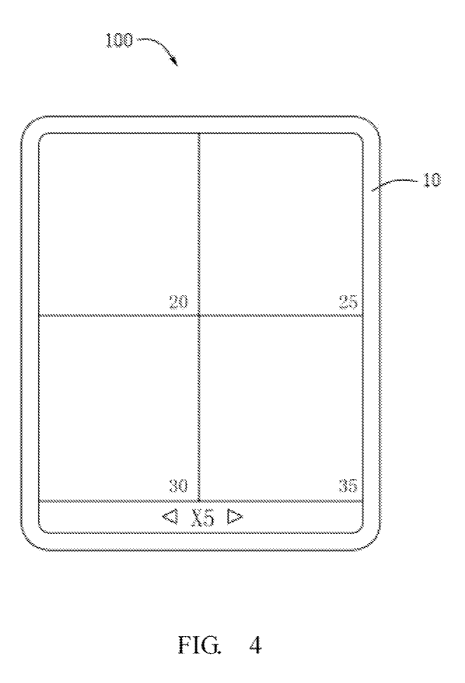

The analysis module 303 determines how many resized pages can to be displayed side by side in the document window according to the last determined resizing proportion of the page 20; the display module 304 further displays the resized pages with continuous or discontinuous in page number in the document window. In the embodiment, the number of resized pages displayed in the document window is four and the four resized pages are continuous in page number in the file (see FIG. 3). Referring to FIG. 4, the four resized pages are discontinuous in page number in the file. There are four pages to be concealed between every two adjacent resized pages displayed in the document window. The number of pages concealed in the document window can be reduced by operating the forward direction button 101 and can be increased by operating the backward direction button 102. In FIG. 3, pages 20 to 23 are displayed. In FIG. 4, pages 20, 25, 30 and 35 are displayed. Pages 21 to 24, 26 to 29, 31 to 34 are concealed.

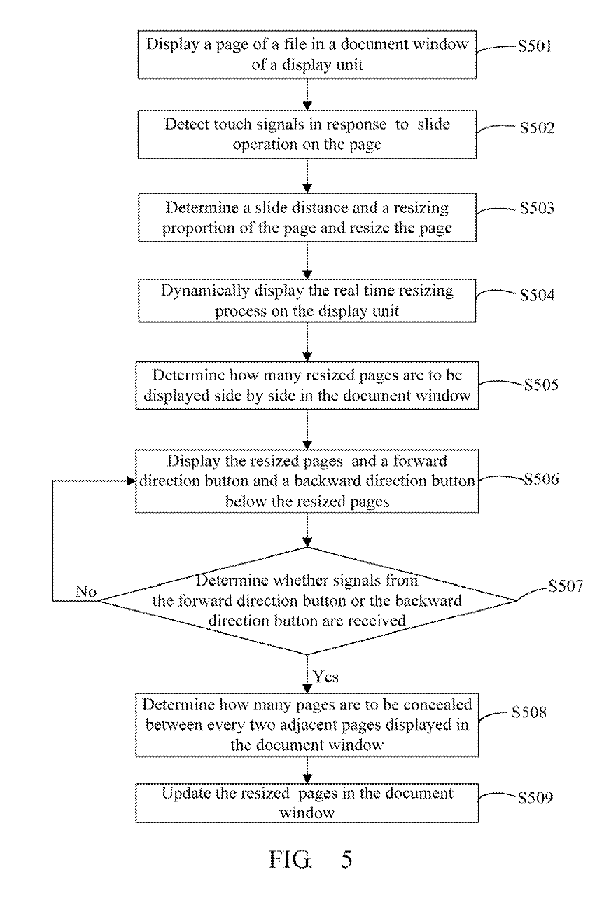

Referring to FIG. 5, showing a method for previewing files of the electronic reader 100 in accordance with an exemplary embodiment.

In step S501, a display module 304 displays a page 20 of a file in a document window of a display unit 10.

In step S502, a detection module 33 detects sliding touch signals in response to the slide operation on the page and transmits the slide touch signals to a calculation module 302.

In step S503, the calculation module 302 determines a slide distance and a resizing proportion of the page 20 corresponding to the slide distance according to a pre-stored table and continuously resizes the page 20 according to the real time resizing proportion. The table records the relation between the slide distance and the resizing proportion of the page 20.

In step S504, a display module 304 dynamically displays the real time resized process on the display unit 10.

In step S505, an analysis module 303 determines how many resized pages can to be displayed side by side in the document window according to the last determined resizing proportion of the page 20.

In step S506, the display module 304 displays the resized pages including the page 20 in the document window and a forward direction button 101 and a backward direction button 102 below the resized pages. In the embodiment, the resized pages are defaulted to be continuous in page number, or defaulted to be discontinuous in page number.

In step S507, the display module 304 determines whether signals from the forward direction button 101 or the backward direction button 102 are received.

If the display module 304 receives signals from the forward direction button 101 or the backward direction button 102, in step S508, the display module 304 determines how many pages are to be concealed between every two adjacent pages displayed in the document window and the procedure goes to step S509; otherwise the procedure goes to the step S506.

In step S509, the display module 304 updates pages in the document window. In detail, if signals from the forward direction button 101 are received, the display module 304 reduces the number of pages concealed. If the pages displayed in the document window are continuous in page number and signals from the forward direction button 101 are received, the display module 304 does not respond to the signals. If signals from the backward direction button 102 are received, the display module 304 increases the number of pages that are concealed.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic reader, comprising:
a storage unit configured for storing electronic files;
a display unit configured for displaying information; and
a processing unit configured for:
displaying a page of an electronic file stored in the storage unit on the display unit;
detecting touch signals in response to a slide operation on an input unit;
determining in real time a slide distance of the slide according to the touch signals and a resizing proportion of the page corresponding to the slide distance to continuously resize the page according to the real time resizing proportion;
determining the number of the resized pages that can be displayed side by side in a document window of the display unit according to the last determined resizing proportion of the page; and
displaying the resized pages in the document window.

2. The electronic reader as claimed in claim 1, wherein the processing unit is further configured to control to dynamically display the real time resizing process on the display unit.

3. The electronic reader as claimed in claim 1, wherein the resized pages displayed in the document window are continuous or discontinuous, one or more pages between every two adjacent pages displayed in the document window are concealed if the pages displayed in the document window are discontinuous.

4. The electronic reader as described in claim 3, wherein the processing unit is further configured to control to display a forward direction button and a backward direction button below the resized pages, the buttons are provided for the users to adjust the number of pages concealed between every two adjacent pages displayed in the document window.

5. The electronic reader as described in claim 1, wherein the storage unit further stores a table which records the relations between a plurality of slide distance and a plurality of resizing proportions for the processing unit to resize the page in real time.

6. The electronic reader as described in claim 1, wherein the input unit is a touch panel overlaying the display unit.

7. A method for previewing files applied in an electronic reader, comprising:
displaying a page of a file on a display unit;
detecting touch signals in responds to a slide operation on an input unit;
determining in real time a slide distance of the slide according to the touch signals and a resizing proportion of the page corresponding to the slide distance to continuously resize the page according to the real time resizing proportion;
determining the number of resized pages that can be displayed side by side in a document window of the display unit according to the last determined resizing proportion of the page; and
displaying the resized pages in the document window.

8. The method as described in claim 7, wherein the resized pages are continuous in page number.

9. The method as described in claim 7, wherein the resized pages are discontinuous in page number.

10. The method as described in claim 7, wherein the method also comprises step: dynamically displaying the real time resizing process of the page on the display unit.

11. The method as described in claim 7, wherein further comprising steps:
displaying at least one button;
determines whether receives signals from the at least one button;
determining the number of pages concealed between every two adjacent pages displayed in the document window if signals from the at least one button are received; and
updating the resized pages in the document window.

12. The method as described in claim 11, wherein the at least one button comprises a forward button and a backward button, the number of pages concealed is reduced when signals from the forward button are received and the number of pages that are concealed is increased when signals from the backward button are received.
